(19) United States
(12) Patent Application Publication
(10) Pub. No.: US 2002/0094580 A1
(43) Pub. Date: Jul. 18, 2002

(54) Photothermal absorbance detection apparatus and method of using same

(76) Inventors: James W. Jorgenson, Chapel Hill, NC (US); Keith E. Fadgen, Chapel Hill, NC (US); Luke T. Tolley, Chapel Hill, NC (US)

Correspondence Address: JENKINS & WILSON, PA, 3100 TOWER BLVD, SUITE 1400, DURHAM, NC, 27707, US

(21) Appl. No.: 09/760,913

(22) Filed: Jan. 16, 2001

(51) Int. Cl. G01N 25/00

(52) U.S. Cl. 436/151; 436/155; 422/100; 422/102; 422/80

(57) ABSTRACT

A photothermal absorbance detection apparatus for performing absorbance measurements of analytes in capillaries having non-conductive walls comprises a light source and a conductivity detection device. The conductivity detection device includes an applied voltage source and at least two electrodes disposed adjacent to the walls of a section of capillary. By using the light source to heat the analytes, the resulting change in conductivity of the liquid containing the analytes can be detected in the liquid. A measurement of absorbance can then be obtained as a function of the change in conductivity.

### TECHNICAL FIELD

The present invention relates generally to the detection and measurement of the optical absorbance of a substance. More specifically, the present invention relates to a photothermal, conductivity-based technique for detecting absorbance in a substance traveling in a fluid conduit.

### BACKGROUND ART

Capillaries constructed from fused silica, polymeric material and other types of non-conductive small-diameter tubes are utilized by scientists and researchers for a variety of purposes. One example is the performance of chemical separations for analytical purposes such as liquid chromatography and mass spectrometry. Absorbance detection is presently one of the most universal methods of sample analysis employed in separation science. Several methods for detection have been proposed or implemented.

The most common methods for making absorbance measurements are optical transmission-based spectroscopies. A transmission-based detector determines the amount of absorbed light in a material by observing slight changes in the amount of transmitted light. Such a system is optically simple, but has an important disadvantage in that the response is directly dependent on optical path length. Consequently, the transmission-based detector does not work well with small capillaries or tubes, especially those having an inner diameter of less than 50 microns.

Other, indirect methods for measuring absorbance can avoid most of the path length dependence, such as photothermal spectroscopic methods that employ refractive index-based photothermal systems. Photothermal spectroscopy generally refers to a class of highly sensitive methods for measuring the optical absorption and thermal characteristics of a sample. The methods based on monitoring refractive index changes resulting from sample heating include photothermal interferometry, photothermal deflection spectroscopy, photothermal lensing spectroscopy, photothermal refraction spectroscopy, and photothermal diffraction spectroscopy. Other methods include calorimetric methods that utilize temperature transducers to measure sample temperature; photoacoustic spectroscopy, which utilizes pressure transducers to measure pressure waves produced by rapid sample heating; and photothermal emission radiometry, which utilizes photometric transducers to monitor changes in infrared emission from samples as a result of heating. A study of these methods has been reported by Bialkowski in “Photothermal Spectroscopy Methods for Chemical Analysis,” Chemical Analysis: A Series of Monographs on Analytical Chemistry and Its Applications, Vol. 134 (1996).

As noted in the literature, photothermal spectroscopic methods are based on the occurrence of a photo-induced change in the thermal state of a sample. These methods of optical absorption analysis have been characterized as being indirect methods. In general, an indirect method does not directly measure the transmission of light used to excite a sample, but rather measures an effect of the optical absorption on the sample. Lasers are often used to transmit light energy to the sample. If light energy is absorbed by the sample and not lost by subsequent emission, the sample will become heated and temperature-related thermodynamic changes in the sample will be observed. Accordingly, photothermal spectroscopic methods are employed to measure changes in temperature, pressure or density occurring as a result of optical absorption. Because sample heating is a direct consequence of optical absorption, signals generated by photothermal spectroscopy are dependent on light absorption. As recognized by those skilled in the art, photothermal spectroscopic methods are more sensitive than transmission-based methods due to the indirect nature of photothermal spectroscopy. That is, photothermal effects amplify the measured optical signal and, to a large degree, shot noise can be avoided.

Laser-induced photothermal refraction techniques have been disclosed by Dovichi et al. in “Theory for Laser-induced Photothermal Refraction,” Analytical Chemistry, Vol. 56, No. 9, August 1984, pp. 1700-1704; by Nolan et al. in “Laser-Induced Photothermal Refraction for Small Volume Absorbance Determination,” Analytical Chemistry, Vol. 56, No.9, August 1984, pp. 1704-1707; by Bornhop et al. in “Simultaneous Laser-Based Refractive Index and Absorbance Determinations within Micrometer Diameter Capillary Tubes,” Analytical Chemistry, Vol. 59, No. 13, Jul. 1, 1987, pp. 1632-1636; and by Yu et al. in “Attomole Amino Acid Determination by Capillary Zone Electrophoresis with Thermooptical Absorbance Detection,” Analytical Chemistry, Vol. 61, No. 1, Jan. 1, 1989, pp. 37-40.

In photothermal spectroscopy, a light source such as a laser emits optical radiation to excite a sample. As the sample absorbs this radiation, its internal energy increases. The change in internal energy results in a change in temperature of the sample, which in turn results in a change in density. If the rapid temperature change occurs faster than the time required for the fluid to expand in response to the increasing internal energy, then a change in pressure will also occur and be dispersed in an acoustic wave. This latter effect also contributes to a density change proportional to temperature. The thermal diffusion and pressure perturbations are consequences of non-radiative excited state relaxation processes, which produce excess energy in the form of heat and thereby cause the internal energy of the sample to be increased and dispersed. In addition, thermal gradients develop between the excited sample and the surrounding fluid. The changes in temperature and density cause changes in other properties, such as refractive index, which can be probed by photothermal spectroscopic techniques.

A major disadvantage of photothermal spectrometric systems such as those adapted to measure refractive index changes is their complexity. A photothermal spectrometer requires two separate light sources and precise optical alignment. A basic system will include one light source for sample excitation and heating, another light source for probing refractive index perturbations, a spatial filter for the probe light, an optical detector for detecting the optically filtered probe light, and electronic signal processing equipment for enhancing the signal-to-noise ratio of the signals generated by the optical detector. These difficulties make refractive index-based photothermal detectors impractical for routine use. Moreover, the refractive index-based technique has not been shown to perform under changing solvent conditions such as a solvent gradient, since every solvent change also changes the refractive index.

Accordingly, the desirability of improvements over existing absorbance detection technology can be readily appreciated by those skilled in the art.

The present invention is provided to solve these and other problems associated with the prior technology. As described hereinbelow, the present invention is characterized in part by its use of a contactless conductivity detection device. The use of contactless conductivity detectors in conjunction with capillary electrophoresis has been disclosed by Zemann et al. in “Contactless Conductivity Detection for Capillary Electrophoresis,” Analytical Chemistry, Vol. 70, No. 3, Feb. 1, 1998, pp. 563-567, in which cationic and anionic compounds are detected after capillary electrophoretic separation; by Fracassi da Silva et al. in “An Oscillometric Detector for Capillary Electrophoresis,” Analytical Chemistry, Vol. 70, No. 20, Oct. 15, 1998, pp.4339-4343, in which an oscillometric detection cell is developed; and by Mayrhofer et al. in “Capillary Electrophoresis and Contactless Conductivity Detection of Ions in Narrow Inner Diameter Capillaries,” Analytical Chemistry, Vol. 71, No. 17, Sept. 1, 1999, pp. 3828-3833, in which the detector disclosed by Zemann et al. is further developed.

### DISCLOSURE OF THE INVENTION

Broadly stated, the present invention provides an apparatus and method for detecting and measuring photothermal absorbance in materials. In particular, the present invention can be successfully and advantageously applied to small diameter capillaries and other tubes or channels, although it will be understood application of the present invention is not limited to such systems. For purposes of the present invention and convenience, the term “capillary” as used herein is taken to mean any type of fluid conduit, such as a tube or a channel, having a small diameter. Preferably, the inside diameter of the capillary is approximately 1 mm or less. More preferably, the inside diameter is approximately 0.2 mm or less or, even more preferably, 0.05 mm or less.

The present invention can further be characterized as providing a conductivity-based photothermal absorbance detector, which combines several of the advantages of both the transmission-based photothermal detector and the refractive index-based photothermal detector. Like the transmission-based system, only a single light source is required in order to take measurements and no complex optics or alignment is necessary. Also, like the refractive index-based system, the response of the system according to the present invention is independent of optical path length. As an added advantage of the present invention, it can be shown from first principles that the relative change in conductivity for a given change in temperature is approximately 32-fold greater than the change in refractive index, which demonstrates that the present invention provides a detector with better sensitivity than heretofore attainable.

In one general, exemplary implementation, an instrument provided in accordance with the present invention can be utilized as a stand-alone absorbance detector for capillary chromatography columns. The present invention can successfully function in conjunction with fused silica capillaries as well as other tubing that is electrically non-conductive and transparent to the radiation incident on the tubing.

Another implementation relates to the current interest in chip-based separations in which “lab-on-a-chip” devices are being developed. These devices almost exclusively employ laser-induced fluorescence detection methods due to the short optical path length of the chip. Laser-induced fluorescence requires that most analytes be tagged with a fluorescent compound, which adds an extra level of complexity and more steps in sample preparation. Apart from the light source, a photothermal detection device provided in accordance with the present invention can be completely integrated with a micro-fluidic device. The resulting novel apparatus provides a detection solution which is much more robust and inexpensive than laser-induced fluorescence, and which does not require sample modification.

According to one embodiment of the present invention, a photothermal absorbance detection apparatus comprises a fluid conduit, a light-emitting device, and a conductivity detection device. The fluid conduit includes a non-conductive conduit wall and defines a detection region. The light-emitting device is adapted to transmit light energy toward the detection region. The conductivity detection device is disposed adjacent to the conduit wall at the detection region. In a preferred embodiment, a contactless conductivity detection device is provided wherein electrodes are disposed outside the conduit wall.

According to another embodiment of the present invention, a photothermal absorbance detection apparatus comprises a fluid conduit, a light-emitting device, an AC signal source, and at least two electrodes such as first and second electrodes. The fluid conduit includes a non-conductive conduit wall and defines a detection region. The light-emitting device is adapted to transmit light energy toward this detection region. The electrodes are connected to the AC signal source. The electrodes are disposed adjacent to the conduit wall at the detection region, and are axially spaced from each other.

According to yet another embodiment of the present invention, a method is provided for detecting the absorbance of analytes. A liquid containing analytes is conducted through a fluid conduit which includes a non-conductive conduit wall and defines a detection region. Light energy is directed at the detection region to heat the analytes as they reach the detection region. As a result, the temperature of the analytes, and thus that of the surrounding liquid, changes and accordingly the conductivity changes as a function of temperature. The change in conductivity is then detected and this change is related to the absorbance of the analytes.

According to still another embodiment of the present invention, a “lab-on-a-chip” or a microfluidic device is adapted to perform photothermal absorbance detection operations. The chip comprises a substrate, a fluid conduit formed on the substrate, and a conductivity detection device including at least two electrodes formed on the substrate. The fluid conduit includes a non-conductive conduit wall and defines a detection region. A light-emitting device is provided for transmitting light energy toward the detection region. The electrodes of the conductivity detection device are disposed adjacent to the conduit wall at the detection region.

It is therefore an object of the present invention to provide a photothermal absorbance detector which has the optical simplicity of transmission-based systems, yet does not have the disadvantages attending transmission-based systems.

It is another object of the present invention to provide a photothermal absorbance detector which is characterized by optical path length independence, such that the detector is suitable for detection in capillaries or small tubes.

It is yet another object of the present invention to provide a photothermal absorbance detector which requires only a single source of light energy for heating a sample.

It is still another object of the present invention a photothermal absorbance detector which measures conductivity changes.

Some of the objects of the invention having been stated hereinabove, other objects will become evident as the description proceeds when taken in connection with the accompanying drawings as best described hereinbelow.

### BRIEF DESCRIPTION OF THE DRAWING

FIG. 1A is a schematic diagram of a photothermal absorbance detector provided in accordance with the present invention, in which analytes approaching a detection region of the detector are illustrated;

FIG. 1B is a schematic diagram of the photothermal absorbance detector, in which the analytes have reached the detection region and absorb light there;

FIG. 1C is a schematic diagram of the photothermal absorbance detector, in which the analytes have left the detection region;

FIG. 2A is a schematic diagram of a contactless conductivity detection device provided as part of the photothermal absorbance detector illustrated in FIGS. 1A-1C, illustrating the capacitive coupling of an AC signal to the core of a capillary;

FIG. 2B is a schematic diagram of the conductivity detection device, illustrating the conduction of the AC signal through the core of the capillary;

FIG. 2C is a schematic diagram of the conductivity detection device, illustrating the capacitive coupling of the AC signal out of the core of the capillary;

FIG. 3 is a schematic diagram of an equivalent electrical circuit modeling the conductivity detection device according to the present invention; and

FIG. 4 is a topological diagram of a chip or a region thereof in which a photothermal absorbance detector is integrated in accordance with the present invention.

### DETAILED DESCRIPTION OF THE INVENTION

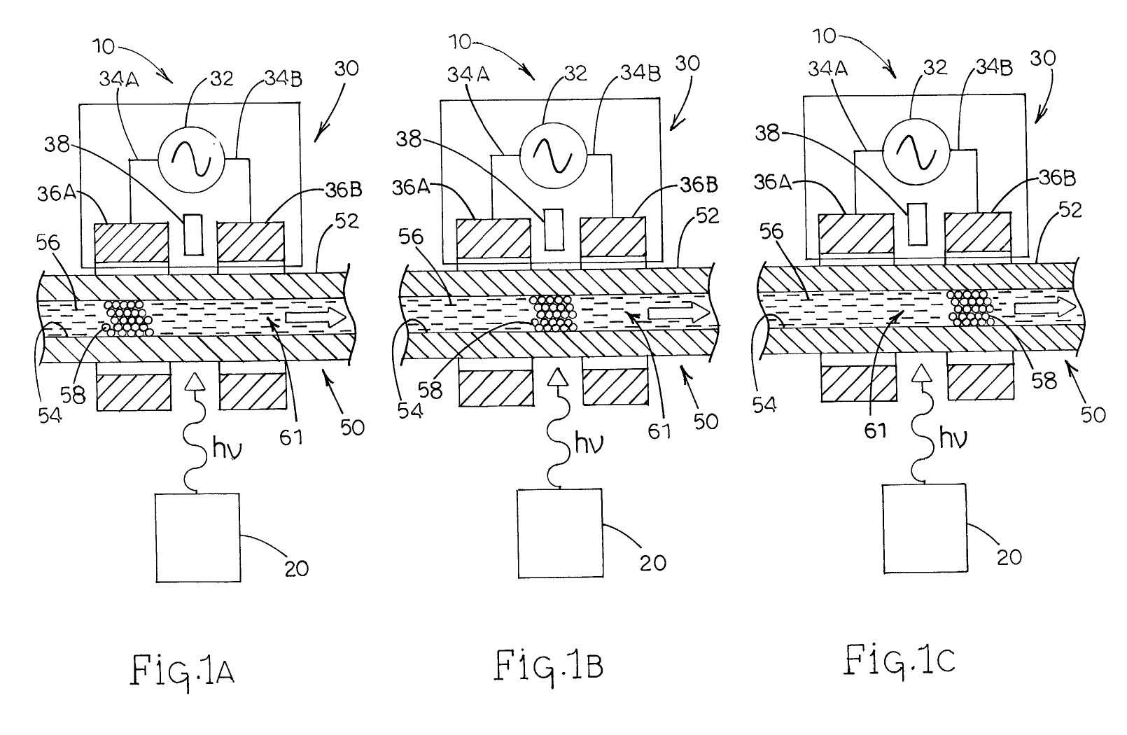

Referring now to FIGS. 1A-1C, a non-limiting example is illustrated of a photothermal absorbance detection apparatus, generally designated 10, according to the present invention. In this embodiment, detection apparatus 10 is particularly designed to perform absorbance measurements inside of fused silica or other non-conductive capillaries (as defined hereinabove) by means of a photothermal technique. Detection apparatus 10 can be broadly characterized as a photothermal detector comprising two primary components: a light source 20 and a conductivity detection device, generally designated 30. Conductivity detector 30 preferably has a contactless design and thus is non-invasive with respect to the liquid or its conduit. Detection apparatus 10 operates in conjunction with a capillary, generally designated 50, whose capillary wall 52 defines a generally cylindrical, hollow capillary core 54 through which a liquid or solution 56 containing analytes 58 flows. Hence, detection apparatus 10 and the illustrated section of capillary 50 on which detection apparatus 10 operates conjoin to define a photothermal detection cell. A computer or other electronic processing device and any associated control and/or signal conditioning and amplification circuitry (not shown) can be provided to communicate with light source 20 and/or conductivity detector 30 to coordinate the respective operations of light source 20 and conductivity detector 30 and process the signal generated by conductivity detector 30.

Referring specifically to FIG. 1A, a group of analytes 58 are illustrated as moving through capillary 50 into the detection cell in the direction shown by the arrow (the sense of this direction has been arbitrarily illustrated as being from left to right). To measure the absorbance of analytes 58, light is focused into the inner diameter of capillary 50. For illustrative purposes, light energy emitted from light source 20 is represented by a single photon or quantum hν of energy, with the reference designation “hν” being taken from the basic equation describing the energy E of a photon: E=hν, where h is Planck's constant (6.6256×10⁻³⁴ Js) and ν is the frequency in s⁻¹. Conductivity detection device 30 effectively has a detection region or “window”, indicated generally at 61, centered around the point of focus of incoming light hν.

Referring next to FIG. 1B, as analytes 58 traveling through capillary 50 move through the detection cell and pass through detection region 61, analytes 58 absorb light energy. Subsequently, some of this light energy is converted to heat energy and is transferred to the surrounding solution 56 inside capillary 50, thereby causing solution 56 to be heated. Because the conductivity of most liquids changes significantly with temperature, the system will detect a conductivity change in solution 56 as analytes 58 absorb light energy.

In this manner, the absorbance of analytes 58 is measured indirectly through the heating process instead of, for instance, by directly measuring a change in the light transmitted to analytes 58. That is, detection apparatus 10 provided in accordance with the present invention indirectly measures the power absorbed, and not the power transmitted as is done by conventional absorbance measurement techniques. The total power incident on the detection cell is equal to the power transmitted through the cell plus the power absorbed in the cell. Generally, the absorbance quantity is equal to the base-10 logarithm of the reciprocal of the transmittance. The transmittance is the power transmitted divided by the power incident. Because detection apparatus 10 measures the power absorbed, the transmittance can be calculated by determining the quantity equal to the power incident minus the power absorbed, and then dividing that quantity by the power incident. The absorbance can then be calculated from the transmittance value obtained. In the actual practice of the present invention, detection apparatus 10 can be calibrated with solutions of known absorbance, so that the measured increase in current is calibrated against absorbance.

Referring to FIG. 1C, once analytes 58 leave detection region 61, no more light is absorbed and thus no further heating occurs.

In the broad context of the present invention, the actual source of the light is noncritical, and light source 20 could be of a type that supplies light energy at a wavelength anywhere from ultraviolet to infrared along the spectrum of electromagnetic radiation. In a preferred embodiment, a laser emitting light at 442 nm is employed as light source 20. Such a laser is specified herein for its small beam diameter and ease of alignment and focus. An example of a laser suitable for purposes of the present embodiment is an HeCd laser commercially available from Liconix company. Other sources of light, however, could be used. Non-limiting examples include a xenon arc lamp, a flashlamp, and a semiconductor laser.

Referring back to FIG. 1A, contactless conductivity detection device 30 includes an AC signal source 32 electrically coupled by lead wires 34A and 34B, respectively, to two electrodes 36A and 36B disposed in proximity to each other and mounted proximate to the outside of capillary wall 52 at the detection cell. Electrodes 36A and 36B are spaced at a distance from each other. Preferably, electrodes 36A and 36B are provided in the form of metallic bands or tubes which are coaxially disposed about capillary wall 52, as shown by the cross-sectional view of FIG. 1A. Contactless conductivity detection device 30 essentially functions by applying an AC signal to these electrodes 36A and 36B, and by capacitively coupling the AC voltage to conductive solution 56 across the dielectric material which forms capillary wall 52. A shield 38 is preferably interposed between electrodes 36A and 36B to reduce their direct capacitive coupling to each other. In preferred embodiments, shield 38 is constructed from a brass or copper material.

While the non-invasive, contactless design described hereinabove for conductivity detection device 30 is preferred, it will be understood that the electrodes employed in the present invention could be installed through capillary wall 52 such that the ends of the electrodes are in direct contact with solution 56.

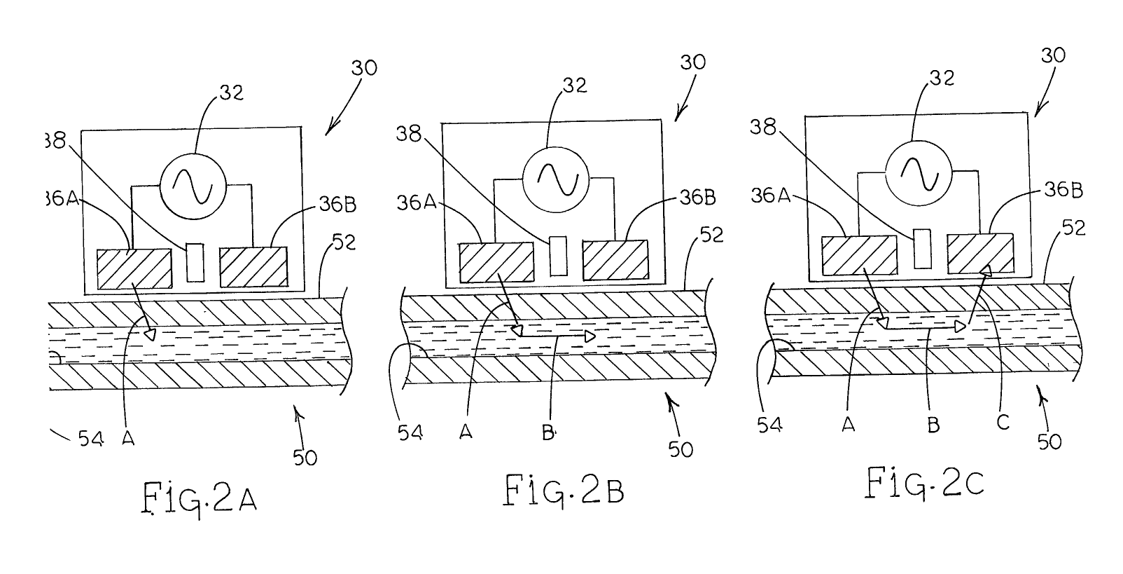

Referring now to FIGS. 2A-2C, as a result of the design of contactless conductivity detection device 30 and the dielectric properties of capillary wall 52, the AC signal from AC source 32 is capacitively coupled between electrode 36A and the conductive liquid in capillary core 54. Referring specifically to FIG. 2A, this capacitive coupling is depicted by arrow A. Referring to FIG. 2B, a potential difference is established within capillary core 54 and causes a current to be conducted through the liquid in the direction generally represented by arrow B. Referring to FIG. 2C, when the current reaches the vicinity of other electrode 36B, the AC signal is capacitively coupled out as depicted by arrow C. Since the capacitance of capillary wall 52 remains fairly constant, the conductivity of the liquid between the two electrodes 36A and 36B is measured without direct contact or the need to perform modifications to capillary 50.

In one operative embodiment of the present invention, light source 20 continuously illuminates detection region 61. As light-absorbing analytes 58 enter the detection cell, light is absorbed and the detection cell is heated. This leads to a decrease in the viscosity of solution 56 and thus an increase in the electrical (ionic) conductivity of solution 56. The change in conductivity is measured by the conductivity detection circuitry described hereinabove.

In a more preferred operative embodiment of the present invention, some type of modulation technique is employed in order to “chop” the light beam incident on the detection cell. Hence, a pulsed light source, or alternatively a rotating wheel having apertures that is interposed in a continuous beam, can be used to provide a modulation frequency for the detection cell of, for instance, 2 Hz.

The utilization of a modulation technique can be desirable for attaining the overall goal of reducing the noise in the output by eliminating many sources of interference. In general, a conductivity detector could detect changes in conductivity that arise from any source, such as changes in the solvent or peaks passing the detection window. In the present invention, however, the only change in conductivity that is of interest is that which occurs as a result of the heating of the sample due to absorption of the light impinging thereupon. Thus, light modulation can be used to isolate the conductivity change of interest from any other conductivity change that might occur. Given that the sample is heated only when it is being irradiated by light, if the light beam is modulated then the sample will heat and cool in sync with the modulation. Accordingly, since the frequency of modulation is known, one can look for a conductivity change that occurs only at that particular frequency and conclude that such conductivity change is due solely to the photothermal effect caused by the operation of light source 20. By monitoring only those conductivity changes that occur at one frequency, other sources of noise and variation, such as the aforementioned solvent changes, are eliminated from consideration.

This isolation of the modulation frequency from the rest of the signal can be accomplished by several techniques. A few non-limiting examples are a lock-in amplifier, a notch filter or a phase-locked loop. In a typical application of the present invention, the frequency of modulation is slow and so, in the case where a lock-in amplifier is employed for isolation of the modulation frequency, a digital type is preferred because of its increased performance at low frequencies as compared to analog instruments, which tend to have difficulty at very low frequencies.

It is possible that isolation of the modulation frequency from the rest of the signal is most easily accomplished through the use of a lock-in amplifier. Accordingly, in one preferred implementation of the present invention, conductivity detection device 30 utilizes a 100 kHz applied waveform and an associated lock-in amplifier element. The light beam supplied by light source 20 is chopped ON and OFF at a low frequency, such as two pulses per second. In this manner, if the AC signal provided by conductivity detection device 30 is passed through a second lock-in amplifier referenced to the chopping frequency, then only those changes in conductivity which are induced by absorption of light will be detected. Since conductivity detection device 30 already utilizes the applied waveform and the first lock-in amplifier, this chopping of the light and use of the second lock-in amplifier constitutes a double-modulation technique. This approach renders the AC signal of conductivity detection device 30 very immune to drift and to other, non-light related sources of conductivity change.

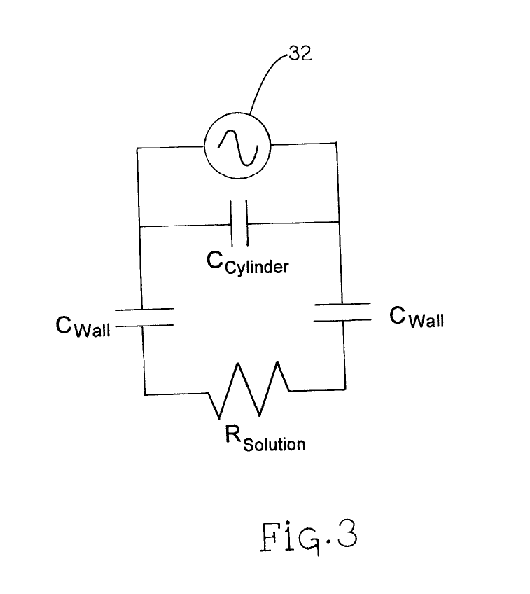

Referring to FIG. 3, the equivalent circuit for detection apparatus 10 is illustrated. AC signal source 32 is placed in parallel with the electrical resistance of the solution flowing through capillary 50. This resistance is represented by a resistor R_{Solution}. Given that resistance varies with temperature and is inversely related to conductance, the present invention could be characterized as being adapted to measure the value for resistor R_{Solution}. The capacitance of capillary wall 52 at each electrode 36A and 36B is represented by capacitor C_{wall}, and is placed in series with each lead connection of AC signal source 32. This capacitance accounts for the capacitance of that portion of capillary wall 52 between electrode 36A or 36B and conductive solution 56. As described hereinabove, capillary wall 52 is constructed from a non-conductive material such as silica glass. Capillary wall 52 is therefore a dielectric material which, rather than conducting current, can only allow electrical charges to accumulate on electrode 36A or 36B and in adjacent solution 56. AC signal source 32 is also placed in parallel with a capacitor C_{cylinder}. This circuit element accounts for both the direct capacitance of capillary wall 52 (i.e., electrode 36A through capillary wall 52 to electrode 36B) and the capacitance of capillary wall 52 plus that of solution 56 (i.e., electrode 36A through capillary wall 52 through solution 56 through capillary wall 52 to electrode 36B). Under most conditions, the magnitude of capacitor C_{cylinder} will be negligible in comparison to the magnitude of capacitor C_{wall}.

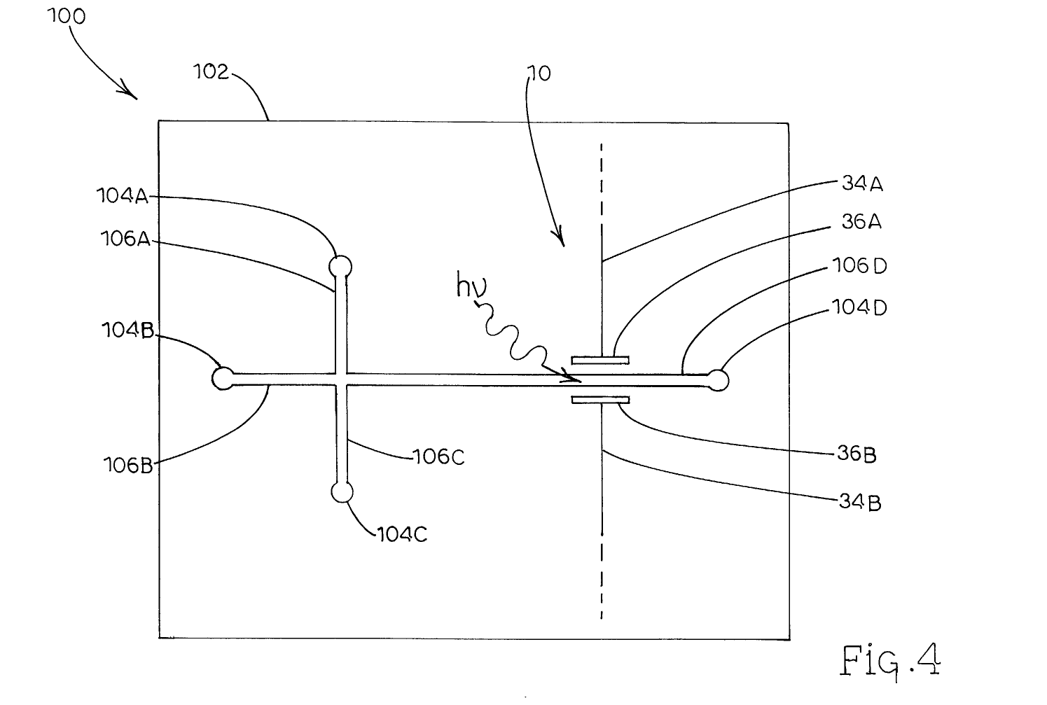

Referring to FIG. 4, a simplified topology of a “lab-on-a-chip” device, generally designated 100, such as a microfluidic device, is illustrated. In accordance with this embodiment of the present invention, photothermal absorbance detection apparatus 10 has been integrated onto a substrate 102. Substrate 102 represents either a full layer of chip device 100 or at least a region thereof. One or more reservoirs 104A-104D are formed on or in substrate 102 and are interconnected by fluid channels 106A-106D. In a non-limiting example, reservoir 104A receives and contains the analyte sample of interest, reservoir 104B receives and contains a solvent, reservoir 104C receives collects waste, and reservoir 104D serves as an outlet. In this case, fluid channel 106D serves a function similar to that of fluid conduit or capillary 50 illustrated in FIGS. 1 and 2. Additionally, electrodes 36A and 36B and their respecting lead connections 34A and 34B, as part of conductivity detector 30, are integrated onto substrate 102, either in the arrangement shown in FIG. 4 or in that shown in FIGS. 1 and 2. Accordingly, a detection cell is defined in or on chip device 100 at which light energy hν is directed, thereby providing a highly miniaturized photothermal absorbance detector. Chip device 100 and its associated components as described herein can be fabricated and assembled according to principles known to those skilled in the art.

It should be noted that contactless conductivity detection device 30, when provided in its contactless form, operates only on capillaries or tubes that are non-conductive. Many of the columns and connecting tubes currently used in analytical equipment such as high-performance liquid chromatography equipment are made of stainless steel, which would not allow detection apparatus 10 to be used. These limitations are inherent in the operation of detection apparatus 10 and cannot be overcome. However, since most conductive materials are not transparent, conventional absorbance detectors would also not work in these circumstances.

It will be understood that various details of the invention may be changed without departing from the scope of the invention. Furthermore, the foregoing description is for the purpose of illustration only, and not for the purpose of limitation—the invention being defined by the claims.

What is claimed is:

1. A photothermal absorbance detection apparatus comprising:
(a) a fluid conduit including a non-conductive conduit wall and defining a detection region;
(b) a light-emitting device adapted to transmit light energy toward the detection region; and
(c) a conductivity detection device disposed at the detection region.

2. The apparatus according to claim 1 wherein the conduit wall is constructed from a fused silica material.

3. The apparatus according to claim 1 wherein the conduit wall has an inside diameter of approximately 1 mm or less.

4. The apparatus according to claim 3 wherein the conduit wall has an inside diameter of approximately 0.2 mm or less.

5. The apparatus according to claim 4 wherein the conduit wall has an inside diameter of approximately 0.05 mm or less.

6. The apparatus according to claim 1 wherein the light-emitting device is a laser source.

7. The apparatus according to claim 6 wherein the laser source is adapted to emit light energy at a wavelength of 442 nm.

8. The apparatus according to claim 1 wherein the light-emitting device is adapted to emit a continuous beam of light energy.

9. The apparatus according to claim 1 including a light modulating device, wherein light energy supplied from the light-emitting device is transmitted toward the detection region at a modulation frequency.

10. The apparatus according to claim 9 including a light chopping device.

11. The apparatus according to claim 9 including a lock-in amplifier operatively communicating with the conductivity detection device.

12. The apparatus according to claim 1 wherein the light-emitting device is adapted to emit a pulsed beam of light energy.

13. The apparatus according to claim 1 wherein the conductivity detection device comprises an AC signal source and first and second electrodes connected to the AC signal source, the first and second electrodes disposed adjacent to the conduit wall at the detection region and axially spaced from each other.

14. The apparatus according to claim 13 wherein at least one of the first and second electrodes is a metal band disposed coaxially about the conduit wall.

15. The apparatus according to claim 13 comprising an electrically isolating shield disposed between the first and second electrodes.

16. The apparatus according to claim 13 wherein the first and second electrodes are radially spaced from an outer surface of the conduit wall to form a contactless conductivity detection device.

17. The apparatus according to claim 13 wherein the first and second electrodes are at least partially disposed within the fluid conduit.

18. The apparatus according to claim 1 comprising an electronic control device electrically communicating with the light-emitting device and the conductivity detection device and adapted to control respective operations of the light-emitting device and the conductivity detection device.

19. A photothermal absorbance detection apparatus comprising:
(a) a fluid conduit including a non-conductive conduit wall and defining a detection region;
(b) a light-emitting device adapted to transmit light energy toward the detection region;
(c) an applied voltage source; and
(d) first and second electrodes connected to the applied voltage source, the first and second electrodes disposed adjacent to the conduit wall at the detection region and axially spaced from each other.

20. The apparatus according to claim 19 wherein the light-emitting device is a laser source.

21. The apparatus according to claim 19 wherein the light-emitting device is adapted to emit a continuous beam of light energy.

22. The apparatus according to claim 19 including a light modulating device, wherein light energy supplied from the light-emitting device is transmitted toward the detection region at a modulation frequency.

23. The apparatus according to claim 19 wherein the light-emitting device is adapted to emit a pulsed beam of light energy.

24. The apparatus according to claim 19 wherein at least one of the first and second electrodes is a metal band disposed coaxially about the conduit wall.

25. The apparatus according to claim 19 wherein the first and second electrodes are radially spaced from an outer surface of the conduit wall to form a contactless conductivity detection device.

26. The apparatus according to claim 19 wherein the first and second electrodes are at least partially disposed within the fluid conduit.

27. A method for detecting the absorbance of analytes comprising the steps of:
(a) conducting a liquid containing analytes through a fluid conduit, wherein the fluid conduit includes a non-conductive conduit wall and defines a detection region;
(b) directing light energy at the detection region to heat the analytes reaching the detection region, whereby the temperature of the liquid surrounding the heated analytes is increased; and
(c) detecting a change in conductivity in the liquid surrounding the analytes occurring as a result of the liquid temperature change.

28. The method according to claim 27 wherein the step of directing light energy at the detection region includes using a light-emitting device.

29. The method according to claim 28 wherein the step of directing light energy at the detection region includes focusing a laser beam into the fluid conduit.

30. The method according to claim 27 wherein the step of directing light energy at the detection region includes directing a continuous beam of light energy at the detection region.

31. The method according to claim 27 comprising the step of chopping the light energy directed at the detection region at a modulation frequency.

32. The method according to claim 27 comprising the step of generating a signal representative of the change in conductivity detected.

33. The method according to claim 32 comprising the step of isolating a portion of the generated signal corresponding to the modulation frequency.

34. The method according to claim 27 wherein the step of directing light energy at the detection region includes directing a pulsed beam of light energy at the detection region.

35. The method according to claim 27 comprising the step of calculating the absorbance of the analytes based on the detected conductivity change.

36. The method according to claim 27 wherein the step of detecting the change in conductivity includes using a conductivity detector disposed adjacent to the conduit wall.

37. The method according to claim 36 wherein the step of detecting the change in conductivity includes using a contactless conductivity detector disposed adjacent to the conduit wall.

38. The method according to claim 37 comprising the steps of providing an AC signal source in electrical communication with at least two electrodes, and placing the electrodes adjacent to the conduit wall.

39. The method according to claim 27 wherein the step of detecting the change in conductivity includes capacitively coupling an AC signal between a first electrode and the liquid in the detection region, and between a second electrode and the liquid in the detection region.

40. The method according to claim 27 comprising the step of providing a fluid conduit having an inner diameter of approximately 1 mm or less.

41. A microfluidic device adapted to perform photothermal absorbance detection operations, the chip comprising:
(a) a substrate;
(b) a fluid conduit formed on the substrate, the fluid conduit including a non-conductive conduit wall and defining a detection region;
(c) a light-emitting device adapted to transmit light energy toward the detection region; and
(d) a conductivity detection device including at least two electrodes formed on the substrate adjacent to the conduit wall at the detection region.
